(19) United States
(12) Patent Application Publication
(10) Pub. No.: US 2013/0220039 A1
(43) Pub. Date: Aug. 29, 2013

(54) Continuously variable transmission

(71) Applicant: Carlos Raul Espinosa-Montalvo, Quito (EC)

(72) Inventor: Carlos Raul Espinosa-Montalvo, Quito (EC)

(21) Appl. No.: 13/385,565

(22) Filed: Feb. 27, 2012

(51) Int. Cl. F16H 19/04

(52) U.S. Cl. 74/29

(57) ABSTRACT

A continuously variable transmission includes: an input movement, a control system, a continuously variable reciprocating movement, a first holder, a second holder, an output gear. The holders having the reciprocating movement. Each of the holders having a linearly movable teeth. The movable teeth are perpendicularly oscillated to the reciprocating movement. Each of the movable teeth having an internal end and an exposed end. The exposed end having a first slope and a second slope. The first slope having a greater slope than the second slope.

### BACKGROUND OF THE INVENTION

This invention relates to continuously variable transmissions.

Continuously variable transmissions transmit movement between an input and an output motion using a control system for determining the ratio of speed or torque.

### BRIEF SUMMARY OF THE INVENTION

A continuously variable transmission is provided. The continuously variable transmission includes: an input movement; a control system; the input movement defines a continuously variable reciprocating movement with the control system; at least one first holder; at least one second holder; the holders having the reciprocating movement; a first adjusting movement is used for positioning the first holder; a second adjusting movement is used for positioning the second holder; the adjusting movements are perpendicularly oriented to the reciprocating movement; the first adjusting movement is alternated to the second adjusting movement; each of the holders having a plurality of linearly movable teeth; the plurality of movable teeth are perpendicularly oscillated to the reciprocating movement; each of the movable teeth having an internal end and an exposed end; each of the plurality of movable teeth having a spring on the internal end; the exposed end having a first slope and a second slope; the first slope having a greater slope than the second slope; at least one output gear is positioned between the holders; the gear having a plurality of outwardly extending teeth; each of the plurality of gear teeth is uniformly distributed along the gear; each of the plurality of gear teeth having the first slope and the second slope; some of the plurality of gear teeth are facing and contacting some of the plurality of movable teeth on at least one of the holders; the plurality of movable teeth are configured and positioned within the holders, for the reciprocating movement, at least one of the plurality of movable teeth is frictionally engaged with at least one of the plurality of gear teeth; at least one of the holders and the gear having a relative movement when at least one of the plurality of movable teeth having an inwardly movement within the holder contacting some of the plurality of gear teeth; and wherein one of the holders and the gear having an interlocking feature when at least one of the plurality of movable teeth having a frictional engagement contacting at least one of the plurality of gear teeth, and the gear having an output movement.

These and other features and advantages of the invention will become apparent to those skilled in the art upon review of the following drawing, the detailed description, and the appended claims.

### BRIEF DESCRIPTION OF THE DRAWING

FIG. 1 is a view of a continuously variable transmission according to the embodiments of the present invention.

FIG. 2 is a diagram comparing adjusting movements of the transmission of FIG. 1.

FIG. 3 is a diagram comparing adjusting movements of the transmission of FIG. 1.

### DETAILED DESCRIPTION OF THE INVENTION

The following description is merely exemplary in nature and is not intended to limit the present disclosure, application, or uses.

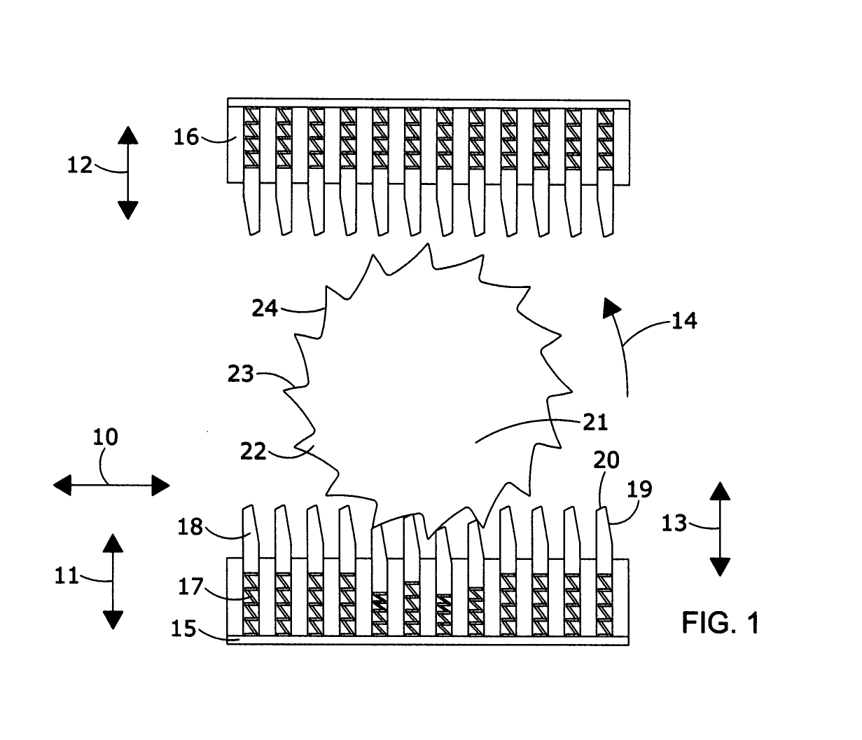

FIG. 1 is a view showing a continuously variable reciprocating movement 10, a first adjusting movement 11, a second adjusting movement 12, a movement 13, and an output movement 14. The movement 13, and the adjusting movements 11 and 12, are perpendicularly oriented to the movement 10. The reciprocating movement 10 is modified by a control system (not shown) on an input movement (not shown). The reciprocating movement 10 is transmitted to a first holder 15 and a second holder 16. A springs 17 and a movable teeth 18 are used within the holders 15 and 16. Each of the movable teeth 18 is connected to each of the springs 17 allowing the movement 13 in the holders 15 and 16. Each of the movable teeth 18 has an external end formed by a slope 19 and a slope 20. The slope 19 is greater than the slope 20. An output gear 21 is positioned between the holders 15 and 16. The gear 21 has a teeth 22. Each of the teeth 22 is formed by a slope 23 and a slope 24. The slope 23 is greater than the slope 24.

Some of the teeth 22 are facing and contacting some of the movable teeth 18 on the holder 15. The reciprocating movement 10 alternates the adjusting movements 11 and 12 for the holders 15 and 16 on the gear 21 respectively. The movable teeth 18 are configured and positioned within the holders 15 and 16, for the reciprocating movement 10, at least one of the movable teeth 18 is frictionally engaged with at least one of the teeth 22.

One of the holders 15 and 16, and the gear 21 have a relative movement when at least one of the movable teeth 18 has an inwardly movement within the holder contacting some of the teeth 22; the inwardly movement is parallel to the movement 13.

One of the holders 15 and 16, and the gear 21 have an interlocking feature when at least one of the movable teeth 18 has a frictional engagement contacting some of the teeth 22, and the gear 21 has the output movement 14.

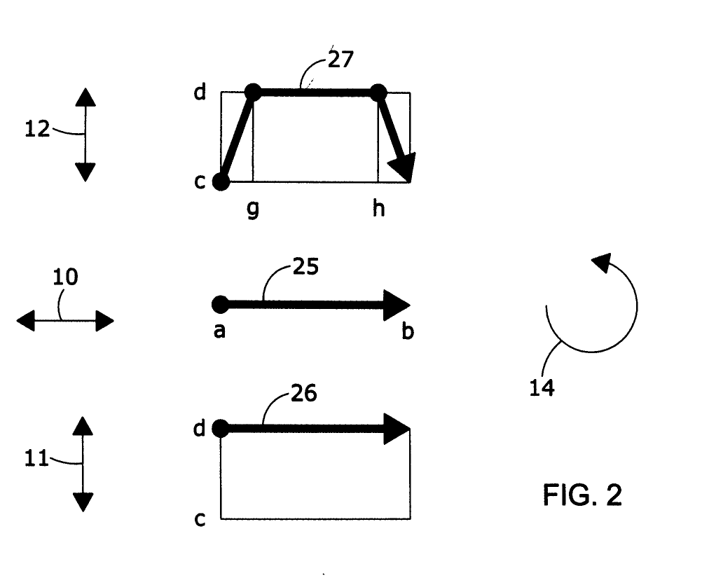

Referring to FIGS. 2 and 1, when the reciprocating movement 10 has a direction 25; the first adjusting movement 11 has a path 26; the second adjusting movement 12 has a path 27; and the gear 21 has the output movement 14. The path 26 defines a hold period for the holder 15. The path 27 describes a transition, activation, and transition period for the holder 16.

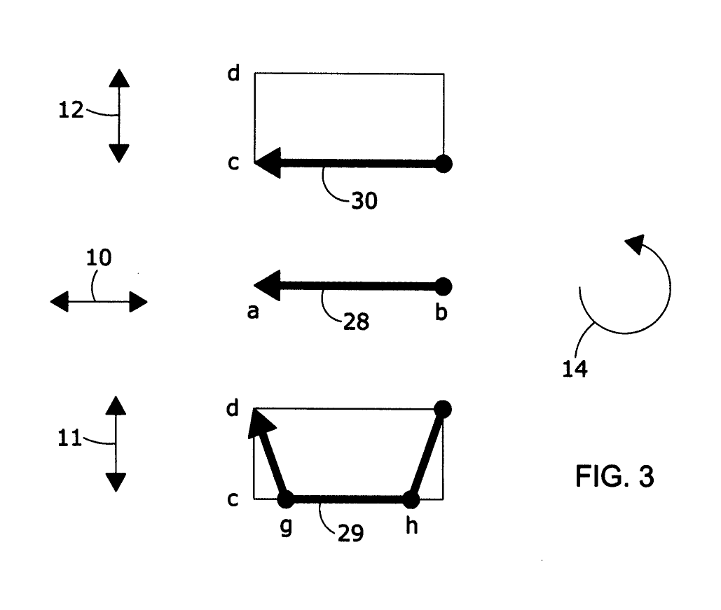

Referring to FIGS. 3 and 1, when the reciprocating movement 10 has a direction 28; the first adjusting movement 11 has a path 29; the second adjusting movement 12 has a path 30; and the gear 21 has the output movement 14. The path 29 represents a transition, activation, and transition period for the holder 15. The path 30 defines a hold period for the holder 16.

Accordingly, the reader will see that the continuously variable transmission of this invention can be used with several types of applications and configurations for transmitting input and output velocities.

Other modifications for the continuously variable transmission of this invention are possible including: a radially movable teeth located on the output gear, and a fixed teeth positioned on the holders; or an axially movable teeth parallel to the rotational axis of the output gear.

The description of the invention is merely exemplary in nature and variations that do not depart from the gist of the invention are intended to be within the scope of the invention. Such variations are not to be regarded as a departure from the spirit and scope of the invention.

What is claimed is:

1. A continuously variable transmission comprising: an input movement; a control system; said input movement defines a continuously variable reciprocating movement with said control system; at least one first holder; at least one second holder; said holders having said reciprocating movement; a first adjusting movement is used for positioning said first holder; a second adjusting movement is used for positioning said second holder; said adjusting movements are perpendicularly movable to said reciprocating movement; said first adjusting movement is alternated to said second adjusting movement; each of said holders having a plurality of linearly movable teeth; said plurality of movable teeth are perpendicularly oscillated to said reciprocating movement; each of said movable teeth having an internal end and an exposed end; each of said plurality of movable teeth having a spring on said internal end; said exposed end having a first slope and a second slope; said first slope having a greater slope than said second slope; at least one output gear is positioned between said holders; said gear having a plurality of outwardly extending teeth; each of said plurality of gear teeth is uniformly distributed along said gear; each of said plurality of gear teeth having said first slope and said second slope; some of said plurality of gear teeth are facing and contacting some of said plurality of movable teeth on at least one of said holders; said plurality of movable teeth are configured and positioned within said holders, for said reciprocating movement, at least one of said plurality of movable teeth is frictionally engaged with at least one of said plurality of gear teeth; at least one of said holders and said gear having a relative movement when at least one of said plurality of movable teeth having an inwardly movement within said holder contacting some of said plurality of gear teeth; and wherein one of said holders and said gear having an interlocking feature when at least one of said plurality of movable teeth having a frictional engagement contacting at least one of said plurality of gear teeth, and said gear having an output movement.

2. The continuously variable transmission of claim 1 wherein said first slope has a coefficient of friction that is higher than that of said second slope.

3. The continuously variable transmission of claim 1 wherein said adjusting movements alternate between a periods for activation, transition and hold.

4. The continuously variable transmission of claim 1 wherein said adjusting movements oscillate using a cam follower mechanism.

5. A continuously variable transmission comprising: an input movement; a control system; said input movement defines a continuously variable reciprocating movement with said control system; at least one first holder; at least one second holder; said holders having said reciprocating movement; a first adjusting movement is used for positioning said first holder; a second adjusting movement is used for positioning said second holder; said adjusting movements are perpendicularly movable to said reciprocating movement; said first adjusting movement is alternated to said second adjusting movement; each of said holders having a plurality of linearly movable teeth; said plurality of movable teeth are perpendicularly oscillated to said reciprocating movement; each of said movable teeth having an internal end and an exposed end; each of said plurality of movable teeth having a spring on said internal end; said exposed end having a first slope and a second slope; said first slope having a greater slope than said second slope;
at least one output gear is positioned between said holders; said gear having a plurality of outwardly extending teeth; each of said plurality of gear teeth is uniformly distributed along said gear; some of said plurality of gear teeth are facing and contacting some of said plurality of movable teeth on at least one of said holders; said plurality of movable teeth are configured and positioned within said holders, for said reciprocating movement, at least one of said plurality of movable teeth is frictionally engaged with at least one of said plurality of gear teeth; at least one of said holders and said gear having a relative movement when at least one of said plurality of movable teeth having an inwardly movement within said holder contacting some of said plurality of gear teeth; and wherein one of said holders and said gear having an interlocking feature when at least one of said plurality of movable teeth having a frictional engagement contacting at least one of said plurality of gear teeth, and said gear having an output movement.

6. The continuously variable transmission of claim 5 wherein said first slope has a coefficient of friction that is higher than that of said second slope.

7. The continuously variable transmission of claim 5 wherein said adjusting movements alternate between a periods for activation, transition and hold.

8. The continuously variable transmission of claim 5 wherein said adjusting movements oscillate using a cam follower mechanism.
